(19) United States
(12) Patent Application Publication
(10) Pub. No.: US 2005/0137843 A1
(43) Pub. Date: Jun. 23, 2005

(54) Method and apparatus for authoring documents using object-based elements as an interaction interface

(75) Inventor: Veronika Lux, Grenoble (FR)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/737,977

(22) Filed: Dec. 18, 2003

(51) Int. Cl. G06F 17/28

(52) U.S. Cl. 704/2

(57) ABSTRACT

Text is created with a high-level interactive authoring systems by associating an object-based element, such as a graphic object, with the linguistic resources of a language processing unit, a user may interact with the system by using the object-based element as an interface. In this way, the flexibility in operating interactive authoring systems, especially for limited-skilled persons or language-impaired persons, is significantly enhanced.

### BACKGROUND OF INVENTION

Generally, the present invention relates to language processing techniques used to assist a user in establishing a natural language text, wherein structure and content of the output text is at least partially controlled by an authoring system.

Globalization of the marketplace offers the potential for selling products all over the world. This effect of globalization may bring about, irrespective of its economical advantages, many problems with respect to the proper use and maintenance of products when sold to persons in different countries who may experience different levels of understanding with regard to such products. For instance, products such as food, medication, and manufactured goods such as printers, cameras, cars, and the like require some level of documentation for educating consumers regarding its proper assembly, use, and/or maintenance.

While improper use of some products such as a camera may only inconvenience a user, incorrectly using or handling other products such as baby food, medications, power tools, and the like may, in contrast, result in grave consequences to the user. Accordingly, increased efforts are being made to provide consumers with appropriate product documentation that: complies with legal regulations, may readily be understood by persons of different levels of education or expertise, and is available in different languages.

Authoring product documentation, even in monolingual form, typically requires a person having some linguistic skills as well as some degree of expertise with respect to the product for which the documentation is being authored. The generation of multilingual product documentation may require further effort to correctly translating text forming part of the product documentation into the desired languages. Consequently, the costs for authoring multilingual product documentation may increase overall production costs as standards for the quality of product documentation increase.

Low-level document authoring tools are available for assisting users in creating product document. Although many such tools may be used to author elements of document content such as strings of characters, pictures, and the like, they provide little support for authoring semantics of document content, which may be useful for increasing the accuracy and quality of product documentation. Moreover, such low-level document-authoring tools provide little if any multilingual document authoring support to efficiently produce product documentation in different languages or in different terminologies.

Efforts have been made and are currently being made to develop high-level document authoring tools that allow authors to specify a document at a high-level of abstraction, possibly independent of the language the author is using to communicate with the authoring system. From this high-level of abstraction, the system is adapted to author a document. Thus, contrary to low-level authoring tools, these high-level authoring tools include, in addition to linguistic resources such as thesauri, lexica, and the like, appropriately encoded rules for combining textual elements in a logically and grammatically consistent manner and outputing natural language text that complies with specified structural and semantic constraints.

For example, one class of high-level document authoring systems is disclosed by Kwes van Deeter and Richard Power in “High-Level Authoring of Illustrated Documents”, published in Information Technology Research Institute Technical Report Series, September 2002. These authoring systems allow authors to specify the content and form of a document including text and pictures at a high level of abstraction. The technique described in this paper is an extension of the so-called “what you see is what you mean” (WYSIWYM) authoring paradigm. Furthermore, according to the proposed technique authors may request an illustration for the text they are currently authoring. To this end, illustrations may be extracted from a database of predefined illustrations that have been indexed or annotated using a specified logic formalism. When an illustration is included in the document being authored, the annotation attached thereto is used to further build the high-level representation of the document, thereby enabling a representation of meanings conveyed by both text and pictures. Thus, by maintaining a link between a text fragment and an image as a whole, reading and understanding of the document may be facilitated.

Another approach of providing a high-level document authoring system is the multilingual document authoring (MDA) system developed by Xerox (referred to herein as the “Xerox MDA System”), which provides controlled generation of domain specific documents in one or more different languages or one or more different terminologies by guiding an author in a structure-dependent and semantic-dependent fashion. The Xerox MDA System provides interactive tools, such as context-aware menus, for assisting monolingual writers in the production of multilingual documents. These tools allow text to be defined in such a way that choices down to the word-level are possible when authoring document content. In addition, dependencies between two distant parts of the document can be specified, such that a change in one part of a document is immediately reflected in a change in some other part of the document. The author's choices (i.e., inputs) are handled so as to have language-independent meanings, which may be automatically rendered in any of the languages and/or terminologies known to the system along with the corresponding grammatical consequences on the surrounding text.

The text produced by the Xerox MDA System is implicitly controlled, syntactically and semantically. For instance, the choice of the standard term for expressing a given notion is under system control, as is the choice among grammatical variants, such as active/passive sentences, for expressing a given piece of information. Moreover, a semantic control is achieved by, for example, reflecting the consequences of a choice on one position of the document across the whole document. When operating the Xerox MDA System, the author is guided in his/her choices. The choices or input values are coded so as to be represented in a typed “abstract-tree” structure, which completely represents the communicative content of the document in a language-independent manner. Hence, the content may be readily provided in a desired language or terminology as long as the system is aware of the linguistic resources for the desired languages and terminologies.

Further background on the Xerox MDA System is disclosed in the following references, which are all incorporated herein by reference and which are referred herein together as the “Xerox MDA Publications”: Caroline Brun, Marc Dymetman, Veronika Lux, “Document Structure and Multilingual Text Authoring”, in the Proceedings of INLG'2000, Mitzpe Ramon, Israel, 2000; Marc Dymetman, Veronika Lux, Aarne Ranta, “XML and Multilingual Document Authoring: Converging Trends”, in the Proceedings of COLING'2000, Saarbrucken, Germany, 2000; Aurelien Max, Marc Dymetman, “Document Content Analysis through Fuzzy Inverted Generation”, in AAAI 2002 Spring Symposium on Using (and Acquiring) Linguistic (and World) Knowledge for Information Access, Stanford University, United States, 2002; Marc Dymetman, “Document Content Authoring and Hybrid Knowledge Bases”, in the Proceedings of KRDB-02 (Knowledge Representation meets Knowledge Bases), Toulouse, France, 2002; and Marc Dymetman, “Text Authoring, Knowledge Acquisition and Description Logics”, in the Proceedings of COLING-02, Taiwan, August 2002.

Although the above-described high-level authoring systems provide for the possibility of establishing domain specific documents, typically a certain degree of skill and experience with respect to the language in general and/or with respect to a certain terminology, is nevertheless necessary for generating documents dealing with sophisticated content, such content in product documentation, which may result in a cost and time-consuming process. Accordingly there continues to exist a need for tools that may be used by authors to facilitate the generation of text for specified applications. Advantagously, such tools would allow authors without specific knowledge, skills or language competency (including language-impaired) to generate a natural language output text of controlled quality.

### SUMMARY OF INVENTION

In accordance with the invention, there is provided a method and apparatus that enables a more flexible interaction with a high-level text authoring system in that an object-based element is used as an “interface” during the authoring phase. For instance, a graphic object may be used as a means for entering input values into the authoring system, wherein the graphic object may represent a simple noun meaning or may represent a highly complex, technical context so that even limited-skilled persons or language-impaired persons may be able to author sophisticated documents.

In accordance with one aspect of the invention, a method of authoring a document comprises providing an interactive document authoring system having implemented therein structural and linguistic resources (i.e., language resources), including textual elements and a set of rules for combining at least some of the textual elements as a natural language text upon user interaction. Then, at least one accessible object-based element is associated with the structural and linguistic resources and the at least one object-based element is accessed so as to interact with the text authoring system.

The combination of a document authoring system with structural and linguistic resources that enable the creation of a document including natural language output text, such as in the Xerox MDA System, with an object-based element, provides for an increased degree of flexibility in establishing the desired output document. Conventionally, the user communicates with the authoring system by, for example, selecting proposed textual elements, which are then properly embedded into the structure and content of the already existing text components of the document, wherein, a language independent representation may be used.

In accordance with another aspect of the invention, a user may interact, additionally or alternatively, with the authoring system by using an object-based element, such as a three-dimensional object, for instance a model of an apparatus to be described, or a two-dimensional graphic object, wherein the object-based element is provided in an accessible form so as to provide an interface function to the authoring system, wherein the association with the structural and linguistic resources ensures a controlled response of the authoring system.

For example, a graphic object or a portion thereof may represent a noun-phrase of a highly specialized terminology, which may thus be selected by the user without requiring the user to be familiar with the terminology. In other cases, the object-based element may even represent a highly complex content, which may intuitively be understood by even limited-skilled persons or which may provide the potential for expressing a complex context intuitively understandable by means of the graphic object even by a language impaired user. Advantageously, the usage of object-based elements as interface may even provide the potential for authoring text in document form with a desired “quality” even if the user is language impaired, or may not be able to read or write at all.

In a further embodiment, associating the at least one object-based element with the structural and linguistic resources comprises relating the at least one object-based element with a textual element contained in the linguistic resources. In this way, the interaction with the authoring system may provide more flexibility since it may be possible to give the author the choice between directly selecting a textual element as an input or accessing the object-based element as a representation of the desired textual element.

In another embodiment, associating the at least one object-based element with the structural and linguistic resources comprises relating the at least one object-based element with a structure determining element of the structural and linguistic resources. Accordingly, the object-based element may be readily used in editing the formal appearance of the desired output text.

In one illustrative embodiment, the at least one object-based element comprises a graphic object. Graphic objects are especially suited for object-based elements acting as an interface, since they may readily be presented on a screen typically used in connection with an authoring system, while a plurality of approved techniques are known so as to access a graphic object. Moreover, graphic objects readily enable the presentation of meanings in an unambiguous way for a huge class of applications. For instance, the image of a technical object, such as a camera, may convey a plurality of terminological phrases without actually requiring the knowledge of these phrases by the person operating the authoring system.

In another illustrative embodiment, the graphic object may comprise an interactive portion accessible by a pointer connected to the interactive text authoring system. In this way, the interactive portion of the graphic object may be directly used as an interface for inputting a specified value into the authoring system. Although accessing of a graphic object or portions thereof may also be achieved by providing, for example, a menu provided at a position not related to the graphic object, the direct access of the interactive portion through the pointer facilitates the communication with the authoring system, especially for persons having low skills with handling a computer device.

In a further illustrative embodiment, the graphic object may comprise a plurality of interactive portions that are accessible by the pointer, wherein each of the plurality of interactive portions is associated with the same element of the structural and linguistic resources of the authoring system.

Linking a plurality of interactive portions with a specified element of the structural and linguistic resources may provide for an improved controllability of the interaction with the authoring system. For instance, upon a user's choice, the content of text included in the document to be authored may contain a certain textual element, for instance, a noun phrase or a verb phrase, which in turn may be associated with the plurality of interactive portions. The occurrence of the specified phrase may then reflect in a response concerning the graphic object. As an example, these interactive portions may be made accessible only as long as the specified noun phrase or verb phrase is relevant. If, for example, the interactive portions of a graphic object represent the front side of a vehicle, a previous choice of the phrase “open” may “activate” as input areas only those portions of the graphic object that may actually be opened in the vehicle. That is, pointing at a headlamp may result in a rejection of the access of this portion of the graphic object, while pointing at the engine hood may effect a corresponding input value for the authoring system.

In yet another illustrative embodiment, the association of the at least one object-based element with the structural and linguistic resources is interactively controlled by the user. The interactive control of linking the object-based element with the resources of the authoring system provides an increased level of flexibility in using the authoring system, since the “response” of the authoring system in accessing the object-based element may be adjusted in accordance with user's interest. For example, a graphic object may be used as the object-based element wherein two or more links to the linguistic resources are pre-established, whereby the user may select one of these pre-established associations actually to be used during the authoring phase, or during a period thereof. In some cases, it may be desirable to use different ways of expressing the same content with different means. For instance, in some portions of a document it may be advantageous to provide an icon represented by a graphic object for conveying a piece of information, while in other portions of the document a textual representation is required. By correspondingly changing the association of the graphic object and the resources of the authoring system, the user may conveniently select an appropriate mode.

In yet a further illustrative embodiment, the method comprises converting a text portion that is output by the interactive text authoring system into spoken language. Providing output text or portions thereof of the document in spoken language allows an advanced flexibility in operating an authoring system in which, in combination with the object-based interaction with the authoring system, even language impaired persons may be able to produce text in a controlled fashion while still being able to control the content and, to a certain degree determined by the configuration of the authoring system, style and/or format of the output document.

In again yet a further illustrative embodiment, a text authoring system comprises a language processing unit including structural and linguistic resources, wherein the language processing unit is configured to form a document including natural language output text based on user selected input values. The authoring system further comprises an interaction interface configured to enable a user to access an object-based element to select an input value for the language processing unit. Hence, the text authoring system according to the present invention enables an increased flexibility in communicating with a user in a manner as specified in the above-described methods.

In one particular embodiment, the language processing unit comprises a multilingual authoring system, such as the Xerox MDA System as previously described, thereby providing the potential for producing an output text in one or more languages or one or more different terminologies.

### BRIEF DESCRIPTION OF DRAWINGS

These and other aspects of the invention will become apparent from the following description read in conjunction with the accompanying drawings wherein the same reference numerals have been applied to like parts, and in which:

FIG. 1 illustrates an interactive authoring system that is adapted to interactively communicate with a user through object-based elements; and

FIGS. 2A-2E illustrate successive steps in operating the interactive authoring system shown in FIG. 1 according to one illustrative example relating to the generation of documentation for operating a camera.

### DETAILED DESCRIPTION

The present invention is based on the idea to use, in addition or alternatively to textual elements, object-based elements as input values for interacting with an authoring system. In this respect, “textual elements” refer to any elements used in a document in that have a written form. For example, a textual element may represent a word, a letter, a text fragment, numbers, punctuation marks, a space, a hyphen, and the like. In contrast, “object-based elements” refer to any elements that may not per se be used in a document to provide semantic or structural contributions to the document. That is, object-based elements may represent non-textual objects in a document in the form of a bitmap image or a graphics object. For example, an icon or illustration, although possibly imparting a specific impression of the meaning it conveys to a viewer, may not be used in generating textual elements in a document, as the structure, syntactic, and semantic relation of the icon or illustration as such in the context of the document is not defined.

According to the present invention, one or more object-based elements, such as illustrations, icons, three-dimensional objects, and the like, are associated with linguistic and structural resources of a document authoring system so as to take advantage of certain aspects of object-based elements that may not be readily described using textual elements. Indeed, an authoring mode based on, for instance, active graphics, may be useful when the author is comfortable with a graphical representation of an object which the document including text to be generated is related to, but is not so comfortable with the vocabulary and terminology typically used in the domain that the object relates. Therefore, the object-based element linked to the linguistic and structural resources of the authoring system may facilitate the generation of text by using the object-based element (e.g., by describing the object using active graphics or a portion thereof rather than choosing an equivalent textual element in a text menu).

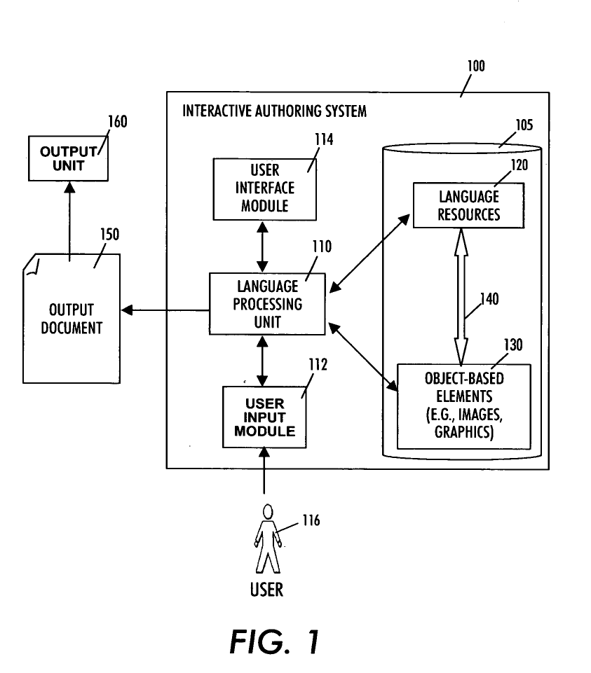

FIG. 1 illustrates an interactive authoring system 100 that is adapted to interactively communicate with a user 116 through object-based elements 130 stored in memory 105. The interactive authoring system 100 includes a language processing unit 110 that accesses in the memory 105 structural and linguistic resources (or otherwise referred to as “language resources”) 120, which may include one or more of language dictionaries, thesauri, lexica, and interaction grammars. The language processing unit 110 is representative of any system that has computational resources adapted to establish, upon interaction with the user 116, a natural language output text on the basis of the resources 120.

In one embodiment, the language processing unit 110 including the structural and linguistic resources 120 includes the Xerox MDA System, described in the Xerox MDA Publications and in U.S. patent application Ser. No. ______, entitled “Systems And Methods For Semantic Stenography” by Dymetman et al., the disclosure of which is hereby incorporated herein by reference. In addition, see U.S. Pat. No. 6,622,123 entitled “An Interactive Translation System And Method”, which is also incorporated herein by reference. In this embodiment, the structural and linguistic resources 120 may include any structural elements and rules that properly format text. Elements and rules that are primarily related to formating text are referred to herein as structural resources. Moreover, the resources 120 may include linguistic resources, such as dictionaries, lexicons, thesauri, and any rules, referred to as interaction grammar, so as to assemble textual elements, such as words, sentence fragments, and the like, in a grammatically correct manner to produce a normal language output text. The resources 120 may also include XML schema or DTDs. In addition, the the Xerox MDA System is adapted to record text during the authoring phase in a language-independent fashion, so that a final output text may be provided in two or more different languages.

The object-based elements forming part of the interactive authoring system 100 include objects such as multi-dimensional graphic objects or bitmap images. The object-based elements 130 are accessible in the sense that the element 130 acts as an interface between the language processing unit 110 and the user 116, wherein the interface function may be realized by any appropriate technique as is well-known in the field of computer technology. For example in one embodiment, the object-based elements 130 may be provided as a graphic object on a user interface module 114 coupled to the language processing unit 110, wherein means are provided so as to select the object-based element or a portion thereof.

Those skilled in the art will appreciate that techniques for generating object-based elements 130 are well known in the art and include image processing and graphic editing tools sold by Adobe Systems Incorporated and Corel Corporation. Input means for selecting object-based elements 130 may be any computer selection means, such as a keyboard, a mouse, a pen, a touch sensitive surface, and the like. Moreover, the object-based elements 130 may represent a physical object of interest or a model thereof, wherein, for instance, some or all portions of the object may be recorded using an imaging system (e.g., a camera, scanner, etc.) or developed using a graphics editing tool and one or more relevant portions of the object may be selected by pointing to the object or a portion thereof, touching, the object, and the like, and wherein the system may then identify the selected portion on the basis of the results of image processing performed on the object.

The object-based elements 130 are associated with the resources 120 by a link or association 140, stored in the memory 105. Depending on the embodiment of the system 100, the object-based elements 130 may be associated with structural resources and/or linguistic resources, wherein the link 140 may be established as a permanent link, or may be designed so as to be altered, controlled, or established interactively. That is, the object-based elements 130, which represent a graphic object, may be configured as an interactive graphic object, wherein portions thereof are assigned to, for instance, certain textual elements, such as noun phrases, and the like. In other embodiments, the link 140 may relate a plurality of object-based elements 130 or a plurality of portions of a single object-based element 130 to a single element of the resources 120. For example, a text fragment indicating a specified action concerning the object-based elements 130 may, upon occurrence in the text established so far, affect object-based portions or elements 130, for instance, by denying or allowing access to all or selected portions or entire elements 130. Similarly, a plurality of elements of the resources 120 may be associated with a single object-based element 130 or a single portion thereof, thereby, for instance, affecting the choice of textual elements available for user interaction that form part of the resources 120.

The interactive authoring system 100 produces as output an output document 150. In some embodiments, the output document 150 may be provided as input to an output unit 160 that may take the form of a display (that may provide interactive capabilities for viewing the output document 150), a printer, an email service, a fax service, or similar rendering or transmission service so as to render and/or transmit the output document 150. Moreover, the output unit 160 may have interface capability so as to allow, possibly in combination with any pointer means, a user interaction with the system 100. In particular, the output unit 160 may be configured to present one or more object-based elements 130 in the form of graphic objects wherein, in one particular embodiment, the graphic objects are established as interactive graphic objects that may be accessed by any appropriate means, such as a keyboard, a mouse, a touch pad, and the like. In other cases, the object-based elements 130 may be provided as any graphic representation, such as an icon, an illustration, and the like, wherein the presentation of the element 130 may be organized in a menu allowing the selection of the object-based element by means of a keyboard, a mouse, and the like. In one embodiment, the output unit 160 comprises a voice synthesizer or voice synthesis unit to present output texts included in the authored document 150 into spoken language.

Prior to and/or during the operation of the interactive authoring system 100, the link or association 140 between the object-based element 130 and the resources 120 may be established, wherein typically the object-based element is selected in conformity with the domain specific aspects. In one embodiment, the system 100 is configured to generate a domain specific text, wherein preferably then the object-based elements 130 convey information about at least a portion of the specified domain. The links to the resources 120 may be achieved by using already existing relations in these resources which are then merely extended to include the object-based element, or new relations to the resources 120 may be created. A typical example for associating the object-based elements 130 with the resources 120 may be to relate portions of an illustration to corresponding text fragments, such as nouns, verbs, and the like.

To illustrate this principle, it is assumed that multilingual documentation is to be prepared for fixing a bicycle tire, wherein the documentation may include several illustrations. Although fixing a bicycle tire is a simple task that may be readily accomplished by any person having moderate experience in using a bicycle, the involved materials, tools, and bicycle components (or terms therefor) may not be readily known, especially not in different languages, by the averaged skilled person. By relating the illustrations and portions thereof to corresponding noun phrases representing tools, chemicals, and bicycle components, a corresponding multilingual instruction may be established without technical skills, wherein, for instance, the style and volume of the instruction may be substantially user controlled, whereas the system 100 assures the correct usage of technical terms. The above example illustrates that a wide variety of applications exists, in which limited-skilled persons may create output documents including texts in many languages with sophisticated content, since the interaction with the authoring system is shifted to a more “intuitive” level.

In some embodiments, it may be considered advantageous to alter, control, or establish one or more of the links 140 interactively. This feature provides for the potential to adapt the authoring system to application requirements and/or user interests, since assigning, for instance, different meanings to a graphic object during the authoring phase seems to be more natural for a graphic object than for a textual element.

In one embodiment, creating links 140 between object-based elements 130 and the structural and linguistic resources 120 involves relating the object-based elements 130 with a structure determining element of the structural and linguistic resources 120. In this embodiment, the object-based elements 130 may be used when editing the formal appearance of the desired output document 150. For instance, accessing the object-based element 130 may be associated with the structural and linguistic resources 120 in such a way that accessing the object-based element 130 results in the insertion of an object represented by an object-based element, wherein the association of the object-based element with the language resources 120 of the authoring system creates assurances that a certain structure and connection to document content is maintained. It may, for example, be desired that a certain icon is always provided in context with a specified text fragment. Thus in this embodiment, accessing the object-based elements 130 may then not only trigger the insertion of the specified icon, but may also assure the correct “neighborhood” of the icon in the document content due to the association to the structural and linguistic resources.

Once an appropriate link 140 is established, the user may communicate with the language processing unit 110, possibly in addition to other interfaces for selecting or entering textual elements, so as to create output text that is controlled by the system 100 in accordance with the capability of the language processing unit 110 and the structural and linguistic resources 120. During authoring of the document, the output unit 160 may present the document at any intermediate stage of authoring in any desired form, that is, in any desired language and/or terminology and/or representation. For instance, for language-impaired persons, text contained in the document may be presented as spoken language so as to facilitate the feedback to the user. In some embodiments, the system 110 may be designed so as to assist persons who cannot read and write in generating specified documents, such as official letters, and the like. In such a case, a user query may be performed by providing possible choices for textual elements to be entered into the system 100 as a voice output, while corresponding object-based elements (e.g., graphic objects) that are readily identified by the user, may be provided, which are then to be activated by the user. A feedback of the user's choice is then also obtained by a voice output of the text of the document established so far.

After the output document 150 is generated, depending on the capabilities of the system 100, a corresponding output document may be generated by the system 100 having the required format and content, wherein the terminology and the language may be selected by the user corresponding to the system's capabilities. For instance, in the embodiment where the Xerox MDA System is used as the language processing unit 110 including the resources 120, output documents 150 which include text written in a plurality of languages may simultaneously be generated.

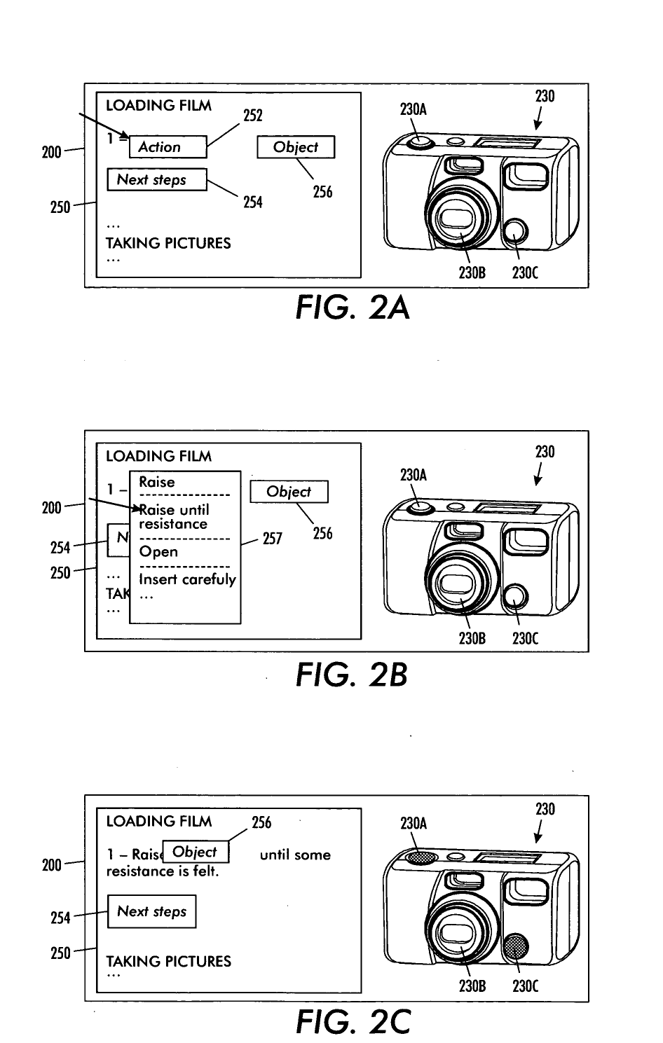

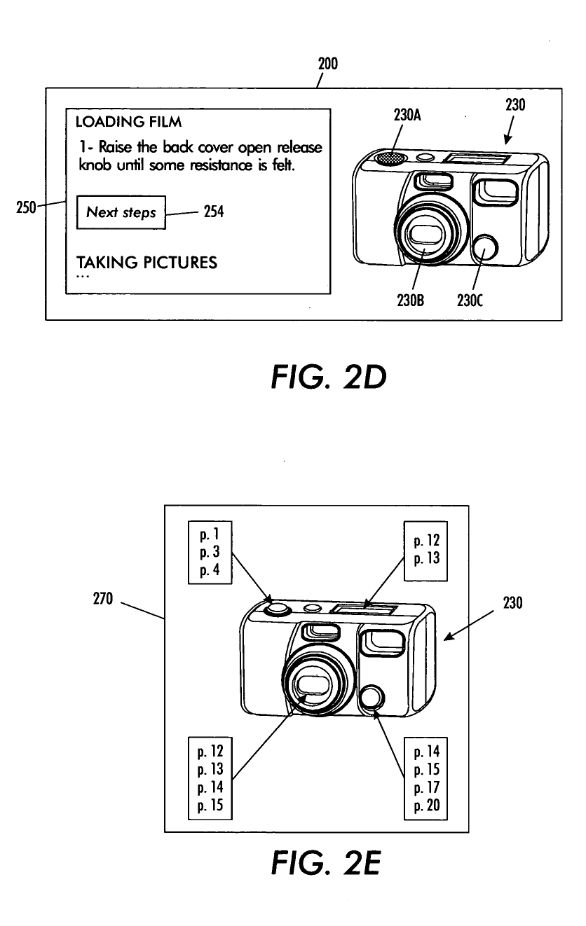

FIGS. 2A-2E illustrate successive steps in operating the interactive authoring system shown in FIG. 1 according to one illustrative example relating to the generation of documentation for operating a camera. It should be appreciated that this example is illustrative of most product documentation that describes product use, handling, maintenance, and upgrades with diagrams and/or figures. For example, FIGS. 2A-2E may be illustrative of other devices, such as DVD user manuals, airplane maintenance manuals, and the like, which typically require some knowledge of technical terms that may even go beyond the skills of a person who is otherwise quite familiar with the technology involved. Likewise, the creation of package inserts and the like may be performed in a similar fashion.

In the example described with reference to FIGS. 2A-2E, a system, such as the system 100, may be used, for instance comprising the Xerox MDA System. In such an assisted interactive authoring environment, typically the author progressively specifies the abstract representation (i.e., the language-independent representation) of the document to be established, wherein this abstract representation is then used as a basis to generate documents including texts in a desired form or in a desired language. Interaction with the user 116 is conventionally done via menus, wherein at each step the system only presents the author with valid choices and excludes alternatives that would not lead to a correct document. In the illustrative example shown in FIGS. 2A-2E, the interaction capacity of such an interactive authoring system is extended by using an “active graphic” as an alternative to menus containing only textual elements. A corresponding active graphic is typically built from an illustrative graphic accompanying the text, as is frequently the case in technical menus.

FIG. 2A shows a user interface 200 produced by the user interface module 114 accessible to the user 116. More specifically, an object-based element 130 is provided in the form of an active graphic object 230 in user interface 200. The graphics object 230 represents a camera for which documentation is to be generated using the language processing unit 110 once links 140 with resources 120 are defined by the user 116. Hence, the object-based element 230 represents the object concerning the text to be established, thereby enabling the user to access different parts of the camera.

In the example, the object-based element 230 may comprise a plurality of active portions 230A, 230B, 230C, which may be accessed by the user 116 when presented, for example, on a display coupled to the interactive authoring system. For instance, the active portions 230A, 230B, 230C may be provided as selectable are as, click-on areas, and the like. A plurality of technical solutions are available to render a graphic “active”. In HTML, for example, clickable or selectable image maps allow one to navigate by clicking on images or parts thereof. In the present example, the action associated with a click event is implemented differently and may lead to refining the specification of an abstract semantic form used by the interactive authoring system. Consequently, one or more new textual elements may be generated in the document or text that is currently being authored.

Other tools for providing active graphics are corresponding languages, such as SVG (Scalable Vector Graphics), which also offer the functionality for using the object-based element 230 as an interactive interface. When selecting one or more of the active portions 230A, 230B, 230C, in the present example the author receives a text fragment used to designate the object selected. In cases where a standard terminology exists, the text fragment may typically represent the standard term associated with the object and stored in a terminology database, which is typically included in the structural and linguistic resources of the interactive authoring system. For instance, the active portions 230A, 230B, 230C may be associated with terms such as “film rewind crank”, “tripod socket”, “rokkor lens”, “self-timer lever” and the like. The corresponding text fragment is then integrated into the text authored, wherein the system makes any necessary linguistic adjustments.

For example, if the Xerox MDA System forms part of the system 100, the implemented mechanism ensuring the semantic consistency of the text may be extended so as to include objects that are reachable via the active graphics. To this end, each object and part of the object, that is, for instance, the object-based element 230 and/or the portions 230A, 230B, 230C thereof are explicitly associated with their (already existing) counterpart element in the abstract grammar. In this way, semantic constraints may be reflected, in addition to a textual input, also by “activating” specific areas of the graphic corresponding to the presently given stage of the authoring process.

For instance, as shown in FIG. 2A, the author is writing instructions to load a film into the camera. Sections entitled “loading film” and “taking pictures” are among the obligatory sections in this type of manual so that their titles already appear at this stage in text 250 of the document that is being authored. Hereby, active areas in the text 250 of the document, that is, parts that are not yet completely specified by the author, may appear in boxes 252, 254, or 256.

As shown in FIG. 2B, when selecting the box 252 labeled “action” in FIG. 2A, the author receives a menu 257 to select between a set of proposed alternatives. In the menu 257 the textual element “raise until resistance” may be selected as the desired action.

FIG. 2C illustrates the text 250 of the document being authored including the updated version with text selections made from menu 257 shown in FIG. 2B, wherein the text represented to the author represents a language independent internal abstract semantic representation of the document. Now, the user 116 may select the box 256 labeled “object” in a graphic mode or in a text mode. In selecting the graphic mode, the user indicates to the system that an object is to be specified, for instance, by using the active graphic 230. As previously indicated, the object 230 may be associated with the linguistic resources in such a way that only relevant portions of the graphic object 230 may be activated by the author. Accordingly, in this example only those parts of the camera object 230 may be accessed by the author that can actually be raised, which are highlighted in objects 230A and 230C. In selecting the text mode, the system displays a menu with selectable text elements similar to the menu 257 shown in FIG. 2B that relate to the corresponding selected object and which text elements may reflect selections made while in the graphics mode.

FIG. 2D shows the text 250 after the user 116 (or author) accessed one of the selectable active objects 230A or 230C shown in FIG. 2C, for instance, by clicking on the selectable active object 230A, wherein the text 250 and the object 230 and their internal abstract representation thereof in the system are correspondingly updated. It will be appreciated that the text 250 authored so far may have also been generated by performing actions in a different order. For instance, the author may have selected an active portion of the graphics 230A corresponding to the “back cover open release knob”, and after updating the text the author may have selected in the correspondingly appearing text menu 257 the action “raise until resistance”.

The active graphics used for authoring the text 250 may also be used as illustrations in the final document. If this document is read on a display screen, the link between the text 250 and their counterparts on the graphic 230 may be maintained and may be shown. For instance, by selecting a text fragment in the text 250, the corresponding part of the object 230 may be highlighted and vice verse. If the document is provided on paper, the links between text fragments and their counterparts on the graphic 230 may be shown by inserting “labels”, both in the text 250 and in the graphic 230. Alternatively, as shown in FIG. 2E, the text 250 and the object 230 may be used to produce a graphical index 270 at any desired position within the output document 150, wherein page numbers are assigned to some or all of the portions of the graphic 230.

It should be appreciated that the above example is of illustrative nature only, and should not be considered as restricting the present invention. In particular, in the above illustrated example, a co-existence of a graphic interface and a textual interface is described that may be advantageous in view of flexibility for interacting with a text authoring system, thereby providing different authoring modes with active graphics with more or less extensive use of graphics and with menus of icons rather than menus of texts. In some embodiments, text may be authored by only interacting with the system by means of object-based elements, such as graphics and icons. For instance, a multilingual education of children who are to young to be able to read and write may be readily accomplished by interacting with the system by means of icons and graphics, whereas the authored text is output by a voice synthesizer. In such a system, the association of object-based elements with the linguistic and structural resources of the authoring system may be altered, for instance by a supervisor or randomly by the system, so as to establish a variety of different texts while using the same graphics or icons to steadily increase the child's skills or to avoid disinterest due to create a new “story” based on the same graphic objects. In other cases, the graphics and icons may be changed upon request or randomly, wher7ein corresponding associations with the linguistic resources are already pre-established in the authoring system so that the child's skills may be gradually increased.

As a result, the present invention provides an improved technique for operating an interactive authoring system by associating object-based elements to the structural and linguistic resources of the system. By providing the potential for visually choosing a specific object, in many cases a significantly faster and more intuitive approach is provided. An authoring mode based on active graphics may provide relative advantages whenever the author considers it more convenient to select a part of the object, provided in the form of an active graphic, than choose a corresponding text equivalent in a menu when the author is not comfortable with the vocabulary and terminology. In particular, in the context of multilingual text generation, object-based elements, such as graphics, are natural “multilingual” members that significantly facilitate the operation of the interactive authoring system. Moreover, documents generated by a system according to the present invention may closely relate text and graphics and can provide, when provided in an electronic format, an “active” and, to some degree, “self-explanatory” document.

Using the foregoing specification, the interactive authoring system 100 may be implemented as a machine (or system), process (or method), or article of manufacture by using standard programming and/or engineering techniques to produce programming software, firmware, hardware, or any combination thereof. It will be appreciated by those skilled in the art that the flow diagrams described in the specification are meant to provide an understanding of different possible embodiments of the invention. As such, alternative ordering of the steps, performing one or more steps in parallel, and/or performing additional or fewer steps may be done in alternative embodiments of the invention.

Any resulting program(s), having computer-readable program code, may be embodied within one or more computer-usable media such as memory devices or transmitting devices, thereby making a computer program product or article of manufacture according to the invention. As such, the terms “article of manufacture” and “computer program product” as used herein are intended to encompass a computer program existent (permanently, temporarily, or transitorily) on any computer-usable medium such as on any memory device or in any transmitting device.

Executing program code directly from one medium, storing program code onto a medium, copying the code from one medium to another medium, transmitting the code using a transmitting device, or other equivalent acts may involve the use of a memory or transmitting device which only embodies program code transitorily as a preliminary or final step in making, using, or selling the invention.

Memory devices include, but are not limited to, fixed (hard) disk drives, floppy disks (or diskettes), optical disks, magnetic tape, semiconductor memories such as RAM, ROM, Proms, etc. Transmitting devices include, but are not limited to, the Internet, intranets, electronic bulletin board and message/note exchanges, telephone/modem based network communication, hard-wired/cabled communication network, cellular communication, radio wave communication, satellite communication, and other stationary or mobile network systems/communication links.

A machine embodying the invention may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method for authoring a document, comprising:
providing an interactive document authoring system having implemented therein structural and linguistic resources including textual elements and a set of rules for combining at least some of the textual elements as a natural language text upon user interaction;
associating at least one accessible object-based element with said structural and linguistic resources; and
accessing said at least one object-based element to interact with said document authoring system.

2. The method of claim 1, wherein associating said at least one object-based element with said structural and linguistic resources comprises relating said at least one object-based element with a textual element contained in the linguistic resources.

3. The method of claim 2, further comprising selecting said textual element as input for said interactive document authoring system upon accessing said object-based element.

4. The method of claim 1, wherein associating said at least one object-based element with said structural and linguistic resources comprises relating said at least one object-based element with a structure determining element of said structural and linguistic resources.

5. The method of claim 4, further comprising selecting said structure determining element as input for said interactive document authoring system upon accessing said object-based element.

6. The method of claim 5, wherein said structure determining element effects an insertion of an object-based representation of said object-based element into a body of text authored with said interactive document authoring system.

7. The method of claim 1, wherein said at least one object-based element comprises a graphic object.

8. The method of claim 7, wherein said graphic object comprises an interactive portion accessible by a pointer connected to said interactive document authoring system.

9. The method of claim 8, wherein said graphic object comprises a plurality of interactive portions accessible by said pointer, each of said plurality of interactive portions being associated with a specified element of said structural and linguistic resources.

10. The method of claim 1, further comprising controlling accessibility of said object-based element on the basis said structural and linguistic resources.

11. The method of claim 10, wherein the accessibility is controlled by selecting a textual element associated with said object-based element.

12. The method of claim 1, wherein associating said at least one object-based element with the structural and linguistic resources is interactively controlled by the user.

13. The method of claim 1, further comprising converting a text portion output by said interactive document authoring system into spoken language.

14. A document authoring system, comprising:
memory for storing language resources, object-based elements, and links between the language resources and the object-based elements;
a language processing unit for forming natural language output text based on user-selected input values; and
user modules coupled to the language processing unit for enabling a user to specify links between the language resources and the object-based elements and select input values for said language processing unit.

15. The document authoring system of claim 14, wherein one of said user modules is configured to present a graphic object to a user, said graphic object representing said object-based element.

16. The document authoring system of claim 15, wherein said one of said user modules is further configured to select said graphic object by a pointer so as to select said input value.

17. The document authoring system of claim 14, wherein one of said user modules is configured to enable to access a textual element of said linguistic resources for selecting said input values.

18. The document authoring system of claim 14, wherein the language processing unit is adapted to provide said natural language output text in at least one of a plurality of user-selectable languages.

19. The document authoring system of claim 15, wherein said one of said user modules is further configured to present said graphic object as an interactive graphic object.

20. The document authoring system of claim 14, wherein said one of said user modules comprises a voice synthesis unit configured to provide said natural language output text into spoken language.

21. A method for authoring a document, comprising:
storing in memory language resources and object-based elements;
enabling a user to specify links between the language resources and the object-based elements and select input values for a language processing unit; and
forming natural language output text based on the user-selected input values.
